(19) United States
(12) Patent Application Publication
(10) Pub. No.: US 2004/0253895 A1
(43) Pub. Date: Dec. 16, 2004

(54) Non-woven wipe having abrasive fibers

(76) Inventor: Massimiliano Castellani, Milano (IT)

Correspondence Address: ARNALL GOLDEN GREGORY LLP, 1201 West Peachtree Street, Atlanta, GA, 30309, US

(21) Appl. No.: 10/657,860

(22) Filed: Sep. 9, 2003

Related U.S. Application Data
(63) Continuation-in-part of application No. 10/458,331, filed on Jun. 10, 2003.

(51) Int. Cl. B32B 5/26; B32B 3/00; D04H 3/00; B32B 27/14

(52) U.S. Cl. 442/381; 428/196; 428/198; 442/414; 442/409; 442/389; 442/361

(57) ABSTRACT

A wipe includes a porous and bulky thermoplastic non-woven carrier web. An absorbent non-woven web including a plurality of philic fibers has a first side and an opposite second side. The first side is disposed adjacent the carrier web. The absorbent web is co-extruded to the carrier web and is secured to the carrier web at a plurality of thermic embossments. An abrasive finish is applied to the second side of the absorbent non-woven web. The abrasive finish includes a plurality of abrasive fibers that are less than 40 microns in diameter.

### CROSS REFERENCE TO A RELATED APPLICATION

This application is a continuation-in-part of U.S. patent application Ser. No. 10/458,331, filed Jun. 10, 2003 (claiming priority thereon), the entirety of which is incorporated herein by reference.

### BACKGROUND OF THE INVENTION

1. Field of the Invention

The invention relates to cleaning supplies and, more specifically, to a non-woven wipe.

2. Description of the Prior Art

Disposable wipes are commonly used in a variety of cleaning applications, from cleaning babies' bottoms when changing diapers to removing grease from auto parts. Wipes may be made from many materials, including wood fibers and spun-bond thermoplastic. The construction of a wipe is a function of the intended application for the wipe. For example, baby wipes generally have a soft surface, whereas industrial-use wipes have a harder surface that facilitates quick removal of dirt.

One existing industrial wipe includes a non-woven material such as a meltblown thermoplastic microfibre layer sandwiched between at least two porous outer layers. At least one of the outer layers includes a bonded-carded web. At least one of the outer layers is a bonded carded web layer. The second outer layer includes a bonded-carded web layer or a spun-bonded layer. An abrasive finish is applied to one of the outer layers. This type of industrial wipe tends to be costly to manufacture due to the three layers applied to it and this wipe requires the use of topical surfactants that make the wipe only temporarily absorbent and unpleasant to use because of foaming.

Therefore, there is a need for a wipe that provides an abrasive finish and that is inexpensive to manufacture.

There is also a need for a wipe that is also strong enough to perform positively during the various uses for which it has been projected

There is also a need for a wipe that is substantially permanently absorbent so as to be able to take back the excess of liquid released during a wiping action

### SUMMARY OF THE INVENTION

The disadvantages of the prior art are overcome by the present invention that, in one aspect, is a wipe that includes a porous and bulky thermoplastic non-woven carrier web. A permanent absorbent non-woven web including a plurality of philic fibers has a first side and an opposite second side. The first side is disposed adjacent the carrier web. The absorbent web is co-extruded to the carrier web and is secured to the carrier web at a plurality of thermic embossments. An abrasive finish is applied to the second side of the absorbent non-woven web.

In another aspect, the invention is an apparatus for manufacturing a wipe. A first reel dispenses a preformed non-woven carrier web. A first meltblown head applies an absorbent non-woven web to a selected side of the carrier web. A hot-melt head applies an abrasive finish to the absorbent non-woven web. A point bond calendar embosses the carrier web to the absorbent non-woven web at a plurality of thermic embossments. The thermic embossments attach the absorbent non-woven web to the carrier web, thereby forming a wipe roll material. A device takes-up the wipe material.

In yet another aspect, the invention is a method of making a wipe in which a porous non-woven carrier web is fed from a first reel to a second reel. An absorbent non-woven web is applied through a melt blown head onto the preformed web. An abrasive finish is applied through a hot-melt head to the absorbent non-woven web. The porous non-woven carrier web, the absorbent non-woven web and the abrasive finish are embossed.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a top perspective view of a wipe, according to one illustrative embodiment of the invention.

FIG. 2 is a top plan view of a portion of a wipe without any embossment.

FIG. 3 is a top plan view of a portion of a wipe including embossment and precutting.

FIG. 4 is a cross-sectional view of the wipe shown in FIG. 3, taken along line 4-4.

FIG. 5 is a schematic diagram of an apparatus and method for manufacturing a wipe according to the invention.

FIG. 6 is a cross-sectional view of a detail of a calendar.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

U.S. Pat. Nos. 5,229,191, issued to Austin, and 4,853,281, issued to Win et al. are hereby incorporated by reference.

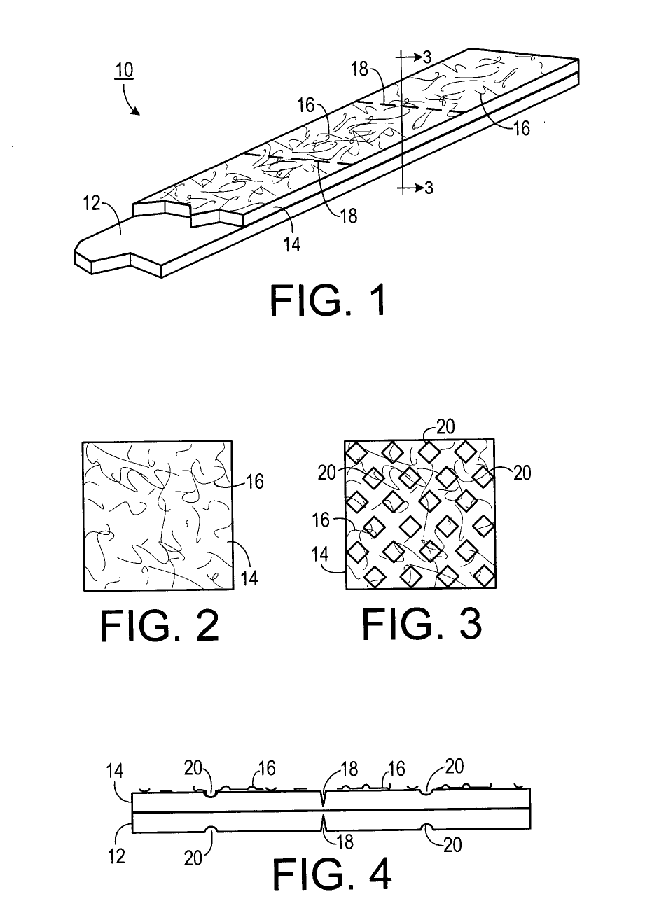

One embodiment of a wipe according to the invention is shown in FIGS. 1-4. The wipe 10 includes a porous and bulky thermoplastic non-woven carrier web 12, an absorbent non-woven web 14 and an abrasive finish 16.

The porous nonwoven carrier web 12 is a carded web partially bounded thermoplastic, and can include between 20 percent to 50 percent bi-component low melting temperature fibers, such as absorbency treated polyethylene and polypropylene. The porous non-woven carrier web 12 has a weight of between 9 grams per square meter and 50 grams per square meter.

The absorbent non-woven web 14 includes a plurality of philic (for example, hydrophilic and oleophilic) thermoplastic fibers and has a first side 13 and an opposite second side 15. The first side 13 is extruded onto the carrier web 12 and secured thereto by a plurality of thermic embossments 20. An abrasive finish 16 is applied to the second side 15 of the absorbent non-woven web. The absorbent non-woven web 14 has a weight of between 9 grams per square meter and 50 grams per square meter.

The abrasive finish 16 comprises a thermoplastic co-polymer and has a weight of between 8 grams per square meter to 20 grams per square meter. Typically, the abrasive finish is made of thermoplastic fibers having a diameter of less than 40 microns, with an average diameter of 15 microns.

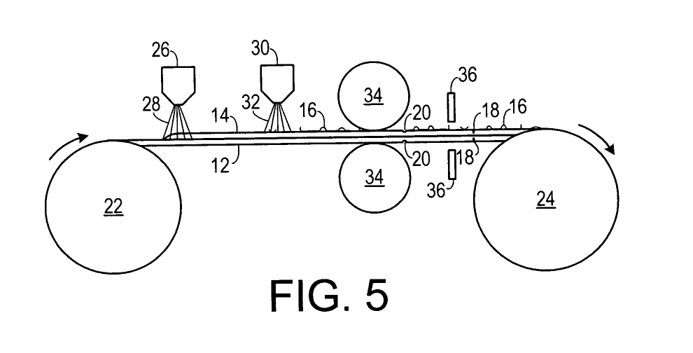

An apparatus for making a wipe according to the invention is shown in FIG. 5. A first supply reel 22 (winder) dispenses the preformed non-woven carrier web 12. A first meltblown head 26 applies a series of threads 28 to the carrier web 12 to foml the absorbent non-woven web 14. Other technologies that can be used to create the absorbent non-woven web 14 include carding, spunbond, perforated film, spunlacing, wet dry laid, air laid, and needle punching. A hot-melt head 30 applies an abrasive finish 16 in the form of a holt-melt beam 32 to the absorbent non-woven web 14. A calendar 34 embosses the carrier web 12 to the absorbent non-woven web 14 at a plurality of thermic embossments 20, thereby attaching the absorbent non-woven web 14 to the carrier web 12. A pre-cutter 36 pre-cuts a plurality of serrations 18 onto the wipe material 10 to facilitate tearing of the wipe material 10 by a user. A second reel (winder) 24 takes-up the wipe material 10.

The embossed roll 34 can be either smooth or pointbonded treated. As shown in FIG. 6, the calendar 34 has an outer surface 38 that defines an embossing surface 40. The embossing surface 40 typically covers between 8 percent to 12 percent of the outer surface 38 of the point bond calendar 34. However, other percentages of coverage would still be within the scope of the invention.

The above-described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A wipe, comprising:
a. a porous and bulky thermoplastic non-woven carrier web;
b. an absorbent non-woven web including a plurality of philic fibers having a first side and an opposite second side, the first side disposed adjacent the carrier web, the absorbent web co-extruded and secured to the carrier web at a plurality of thermic embossments; and
c. an abrasive finish applied to the second side of the absorbent non-woven web, the abrasive finish including a plurality of abrasive fibers that are less than 40 microns in diameter.

2. The wipe of claim 1, wherein the plurality of abrasive fibers have an average diameter that is substantially 15 microns.

3. The wipe of claim 1, wherein the porous nonwoven carrier web comprises a carded web partially bounded thermoplastic.

4. The wipe of claim 1, wherein the porous non-woven carrier web comprises a thermoplastic.

5. The wipe of claim 4, wherein the porous non-woven carrier web comprises between 20 percent to 50 percent bi-component low melting temperature fibers.

6. The wipe of claim 5, wherein the bi-component low melting temperature fibers comprise absorbency treated polyethylene and polypropylene.

7. The wipe of claim 4, wherein the porous non-woven carrier web has a weight of between 9 grams per square meter and 50 grams per square meter.

8. The wipe of claim 1, wherein the absorbent non-woven web comprises a thermoplastic.

9. The wipe of claim 8, wherein the absorbent non-woven web has a weight of between 9 grams per square meter and 50 grams per square meter.

10. The wipe of claim 1, wherein the abrasive finish comprises a thermoplastic co-polymer.

11. The wipe of claim 10, wherein the abrasive finish has a weight of between 8 grams per square meter to 20 grams per square meter.

12. The wipe of claim 1, further comprising an embossment applied to the porous non-woven carrier web, the absorbent non-woven web and the abrasive finish.
